(19) United States
(12) Patent Application Publication
(10) Pub. No.: US 2024/0038244 A1
(43) Pub. Date: Feb. 1, 2024

(54) SPEAKER IDENTIFICATION APPARATUS, METHOD, AND PROGRAM

(71) Applicant: NEC Corporation, Minato-ku, Tokyo (JP)

(72) Inventors: Qiongqiong Wang, Tokyo (JP); Takafumi KOSHINAKA, Tokyo (JP)

(73) Assignee: NEC Corporation, Minato-ku, Tokyo (JP)

(21) Appl. No.: 18/268,536

(22) PCT Filed: Dec. 25, 2020
(86) PCT No.: PCT/JP2020/048744

§ 371 Date: Jun. 20, 2023

(51) Int. Cl. G10L 17/08; G10L 17/02

(52) U.S. Cl. CPC G10L 17/08; G10L 17/02

(57) ABSTRACT

A speaker subset selection means 81 selects speakers corresponding to an attribute from subset information of an entire speaker to determine a subset of a speech model from which test utterance is identified. A speaker identification means 82 identifies a speaker of the test utterance from a subset of the determined speech model based on features extracted from the test utterance.

### TECHNICAL FIELD

The disclosure relates to a speaker identification apparatus, speaker identification method, and speaker identification program for identifying a speaker based on detected speech.

### BACKGROUND ART

In speaker identification, an utterance from an unknown speaker is analyzed and compared with speech models of known speakers. The unknown speaker is identified as the one whose model best matches the input utterance. Speaker identification has helped reducing human resources in various applications such as telephone banking, call centers, etc.

For example, Patent Literature 1 discloses a voice operation apparatus that improves the accuracy of speaker identification. The apparatus disclosed in the Patent Literature 1 uses GPS (Global Positioning System) information input from a GPS device to calculate the location where a voice control device is located, and selects a desired voice quality model from a plurality of voice quality models registered for each user according to the location information.

### CITATION LIST

### Patent Literature

[PTL 1]

WO2019/021953

### SUMMARY OF INVENTION

### Technical Problem

On the other hand, in speaker identification, the number of decision alternatives is equal to the size of the population. And identification performance decreases as population size increases. In other words, efficiency and accuracy of speaker identification are affected by how many users enrolled in the identification system.

Therefore, in order to improve the efficiency and accuracy of speaker identification, it is important to narrow down the matching range for speaker identification.

The voice operation apparatus disclosed in the Patent Literature 1 uses GPS information to select a voice quality model suitable for the surrounding environment. Therefore, even if the accuracy of speaker identification can be improved by narrowing down the conditions of the environment, it is difficult to improve the efficiency of speaker identification because it is difficult to narrow down the range of the target speaker.

It is an exemplary object of the disclosure to provide a speaker identification apparatus, speaker identification method, and speaker identification program that can improve the efficiency and accuracy of speaker identification.

### Solution to Problem

A speaker identification apparatus including: a speaker subset selection means which selects speakers corresponding to an attribute from subset information of an entire speaker to determine a subset of a speech model from which test utterance is identified; and a speaker identification means which identifies a speaker of the test utterance from a subset of the determined speech model based on features extracted from the test utterance.

A speaker identification method including: selecting speakers corresponding to an attribute from subset information of an entire speaker to determine a subset of a speech model from which test utterance is identified; and identifying a speaker of the test utterance from a subset of the determined speech model based on features extracted from the test utterance.

A speaker identification program for causing a computer to execute: a speaker subset selection process of selecting speakers corresponding to an attribute from subset information of an entire speaker to determine a subset of a speech model from which test utterance is identified; and a speaker identification process of identifying a speaker of the test utterance from a subset of the determined speech model based on features extracted from the test utterance.

### BRIEF DESCRIPTION OF DRAWINGS

FIG. 1

It depicts an exemplary block diagram illustrating the structure of a first exemplary embodiment of a speaker identification apparatus according to the disclosure.

FIG. 2

It depicts an example of a general process of speaker identification by comparing test utterances with a speech model.

FIG. 3

It depicts an illustration of an example of a speaker identification method.

FIG. 4

It depicts an illustration of an example of the process by which the speaker identification apparatus of the first exemplary embodiment performs speaker identification.

FIG. 5

It depicts an illustration of an example of a method by which the speaker identification apparatus of the first exemplary embodiment performs speaker identification.

FIG. 6

It depicts a flowchart illustrating the process of the first exemplary embodiment of the speaker identification apparatus.

FIG. 7

It depicts an exemplary block diagram illustrating the structure of a second exemplary embodiment of a speaker identification apparatus according to the disclosure.

FIG. 8

It depicts an illustration of an example of the method by which the speaker identification apparatus of the second exemplary embodiment performs speaker identification.

FIG. 9

It depicts a flowchart illustrating the process of the second exemplary embodiment of the speaker identification apparatus.

FIG. 10

It depicts an exemplary block diagram illustrating the structure of a first specific example of the speaker identification apparatus according to the disclosure.

FIG. 11

It depicts an exemplary block diagram illustrating the structure of a second specific example of the speaker identification apparatus according to the disclosure.

FIG. 12

It depicts an exemplary block diagram illustrating the structure of a third specific example of the speaker identification apparatus according to the disclosure.

FIG. 13

It depicts an exemplary block diagram illustrating the structure of a fourth specific example of the speaker identification apparatus according to the disclosure.

FIG. 14

It depicts an exemplary block diagram illustrating the structure of a fifth specific example of the speaker identification apparatus according to the disclosure.

FIG. 15

It depicts a block diagram illustrating an outline of the speaker identification apparatus according to the disclosure.

FIG. 16

It depicts a schematic block diagram illustrating a configuration of a computer according to at least one of the exemplary embodiments.

### DESCRIPTION OF EMBODIMENTS

The following describes an exemplary embodiment of the disclosure with reference to drawings. Note that the unidirectional arrows shown in each block diagram are a straightforward indication of the direction of information flow and do not exclude bidirectionality.

### First Exemplary Embodiment

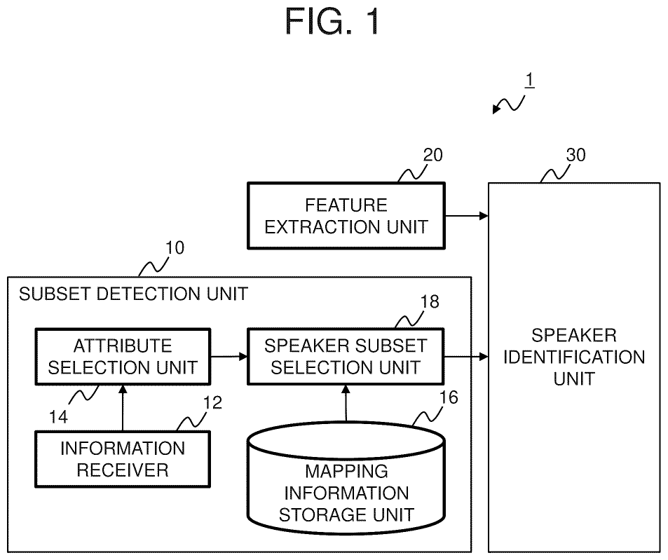

FIG. 1 depicts an exemplary block diagram illustrating the structure of a first exemplary embodiment of a speaker identification apparatus according to the disclosure. The speaker identification apparatus 1 according to the first exemplary embodiment includes a subset detection unit 10, a feature extraction unit 20, and a speaker identification unit 30.

The subset detection unit 10 has a function of detecting a subset of speakers to be identified as a candidate for identification from the entire of speakers to be assumed. In other words, it can be said that the subset detection unit 10 narrows down the range of matching with the speaker. The subset detection unit 10 includes an information receiver 12, an attribute selection unit 14, a mapping information storage unit 16, and a speaker subset selection unit 18.

The information receiver 12 receives information from a receiver that estimates the position of an utterance emitted by a speaker to be identified (hereinafter referred to as the test utterance). In other words, the information receiver 12 obtains information that identifies a region where one or more speakers who are candidates for identification are present. The information receiver 12 may receive location information indicating the longitude and latitude, for example, from a GPS.

Otherwise, the information receiver 12 may receive the location information from a robot, which is a receiver that transmits location information according to the location of the installation, (in other words, a robot having a sensor that detects the location) for example. Examples of location information include information indicating the location of a building (e.g., a school, a hotel, a store, a prison, etc.) and information indicating the location of an indoor room (e.g., a classroom, a guest room, a floor, a cell, etc.). The location information is not limited to information that directly indicates a location, but may be information that can indirectly identify a location where a speaker who is a candidate for identification exists. For example, lecture information may be used as attribute information that can indirectly identify a location. By using the lecture information, it is possible to identify the location of the room in which the lecture is held and the like.

Also, for example, even in the same classroom, as in a school classroom, if the time of day is different, the students (speakers) to be identified are different because the lectures (attributes) are different, even if they are in the same classroom. Therefore, the information receiver 12 may receive not only location information, but also the time and time of day when the speaker identification is performed.

The attribute selection unit 14 selects an attribute of the speaker based on the location information received by the information receiver 12. Herein, an attribute in the disclosure means a characteristic of the speaker and also includes a meaning indicating an affiliation or a classification of the speaker. The mapping between the location information and the attribute is predetermined by the user or others, and the attribute selection unit 14 selects the attribute of the speaker according to the mapping.

For example, if the location information is information indicating a location in a prison, the attribute is a cell ID, which is information identifying a cell in which a prisoner is incarcerated in the prison. For example, if the location information is information indicating a location in a school, the attribute is a room number, which is information that identifies a classroom where a student is receiving a lecture.

When the time at which the speaker identification is performed is received from the location receiver 12, the attribute selection unit 14 may select an attribute of the speaker in consideration of the location at which the speaker identification is performed (e.g., the location of the speaker identification apparatus) and the above time.

The mapping information storage unit 16 stores information mapping an attribute to one or more speakers. This information may be referred to hereafter as subset information. The mapping between an attribute and a speaker is predetermined by the user or others. The subset information in this disclosure is information that indicates a part of all the speakers to be candidates, and not a part of the speakers in the attribute.

For example, for all prisoners in a prison, the subset information is mapping information between the prisoner ID and the cell ID. Otherwise, for all students in a university, the subset information is mapping information between the student ID and the lecture ID. Also, for all subjects in quarantine in hotels or cruise ships, the subset information is the mapping information between subjects and room numbers. In addition, for all students in dormitory, the subset information is mapping information between the student ID and room numbers. For customers registered at any of the stores in the chain, the subset information is the mapping information between the customer ID and the store ID. The subset information listed here is an example, and the mapping information storage unit 16 may store any subset information. The mapping information storage unit 16 is realized, for example, by a magnetic disk or the like.

Furthermore, the mapping information storage unit 16 may store a speech model (reference model) corresponding to the speaker. Examples of the speech model (reference model) includes, for example, a Gaussian Mixture Model (GMM), an i-vector, an x-vector, and the like. In the above examples, the speaker is a prisoner, a student, a subject, and a customer.

The speaker subset selection unit 18 selects a subset of the speaker from the subset information stored in the mapping information storage unit 16 based on the attribute selected by the attribute selection unit 14. The speaker subset selection unit 18 may also acquire a speech model corresponding to the speaker included in the acquired subset from the mapping information storage unit 16.

If the speech model (reference model) is stored in an external storage unit (not shown) that is not the mapping information storage unit 16, the speaker subset selection unit 18 may obtain the speech model corresponding to the speaker from that external storage unit.

The feature extraction unit 20 performs feature extraction of the test utterance. Specifically, the feature extraction unit 20 may, for example, extract utterance features by converting the signal of the test utterance to A/D and applying a discrete Fourier transform, z-transform, or the like to the digital data after conversion. The method by which the feature extraction unit 20 performs feature extraction is arbitrary, as long as the method is capable of extracting features used by the speaker identification unit 30, which will be described below, to identify the speaker. The feature extraction unit 20 may, for example, extract the features based on the framework of the i-vector. The feature extraction unit 20 may also extract features based on deep speaker embedding or an x-vector scheme.

The speaker identification unit 30 performs speaker identification based on the extracted features. Specifically, the speaker identification unit 30 identifies a speaker of the test utterance from a subset of the determined speech model based on the features extracted by the feature extraction unit 20. The method of speaker identification based on the features is optional.

For example, when the features are extracted based on the framework of the i-vector, the speaker identification unit 30 may use the i-vector as a speech model (reference model) and calculate the similarity by PLDA (probabilistic linear discriminant analysis). Specifically, the speaker identification unit 30 calculates the similarity between the speech model in the subset and the features. The speaker identification unit 30 may identify the speaker corresponding to the speech model with the highest similarity as the speaker of the test utterance.

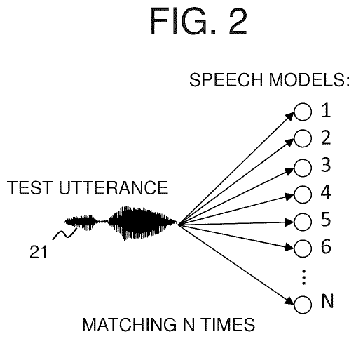

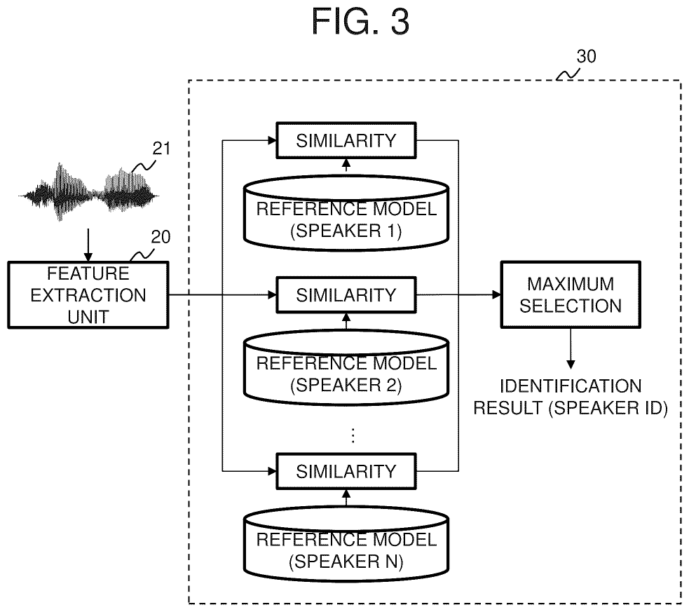

FIG. 2 illustrates an example of a general process of speaker identification by comparing test utterances with a speech model. FIG. 3 is an illustration of an example of a speaker identification method. The process illustrated in FIG. 2 represents the process of comparing the speech models of all the N speakers and the test utterances 21, respectively, N times on a one-to-one basis. Specifically, as illustrated in FIG. 3, when the feature extraction unit 20 extracts the features from the test utterances 21, the speaker identification unit 30 calculates the similarity between the utterances and the speech model of each speaker. Then, the speaker identification unit 30 selects the speaker (speaker ID) with the highest similarity as the identification result from the target speakers.

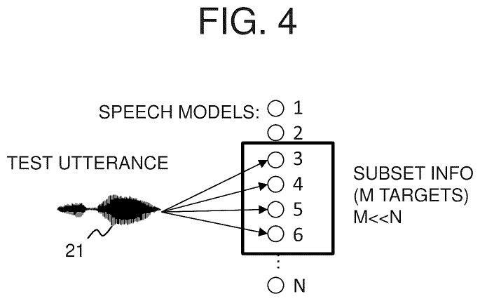

FIG. 4 is an illustration of an example of the process by which the speaker identification apparatus of the present exemplary embodiment performs speaker identification. The example in FIG. 4 shows that the speech models of the four speakers are compared to the test utterances among all N speakers in the target population. Note that FIG. 4 shows an example of a subset of four consecutive speakers, but there is no need to be successive. That is, the speaker subset selection unit 18 need only determine one subset by grouping together a number of speech models in which the test speech is identified.

For example, if the number of prisoners incarcerated in a prison exists in the hundreds, the number of prisoners in one cell is at most a few. That is, for the total number of speakers N, the number of speakers in the subset M can be said to be M «N.

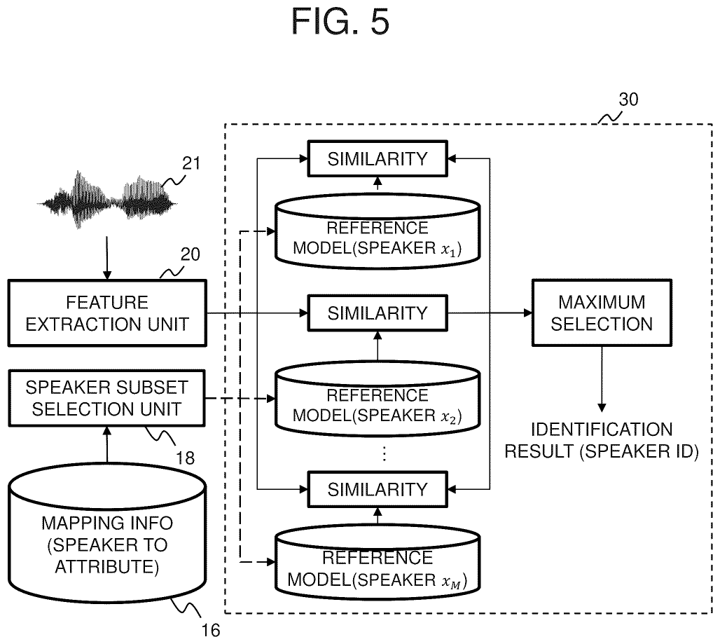

FIG. 5 is an illustration of an example of a method by which the speaker identification apparatus of the present exemplary embodiment performs speaker identification. As illustrated in FIG. 5, in the present exemplary, the speaker identification unit 30 calculates the similarity between each speaker's speech model and utterances using the speech models of a subset of speakers, and selects the speaker with the highest similarity (speaker ID) as the identification result. By narrowing down the candidate speakers, the number of times the test utterances are compared with the speech model of the speaker to be compared with the test utterances can be significantly reduced, thus improving the efficiency and accuracy of speaker identification.

The subset detection unit 10 (more specifically, the information receiver 12, the attribute selection unit 14, and the speaker subset selection unit 18) are implemented by a CPU of a computer operating according to a program (speaker identification program). For example, the program may be stored in a storage medium (not shown) provided by the speaker identification apparatus 1, with the CPU reading the program and, according to the program, operating as the subset detection unit 10 (more specifically, the information receiver 12, the attribute selection unit 14, and the speaker subset selection unit 18). The functions of the speaker identification apparatus 1 may be provided in the form of SaaS (Software as a Service).

The subset detection unit 10 (more specifically, the information receiver 12, the attribute selection unit 14, and the speaker subset selection unit 18) may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

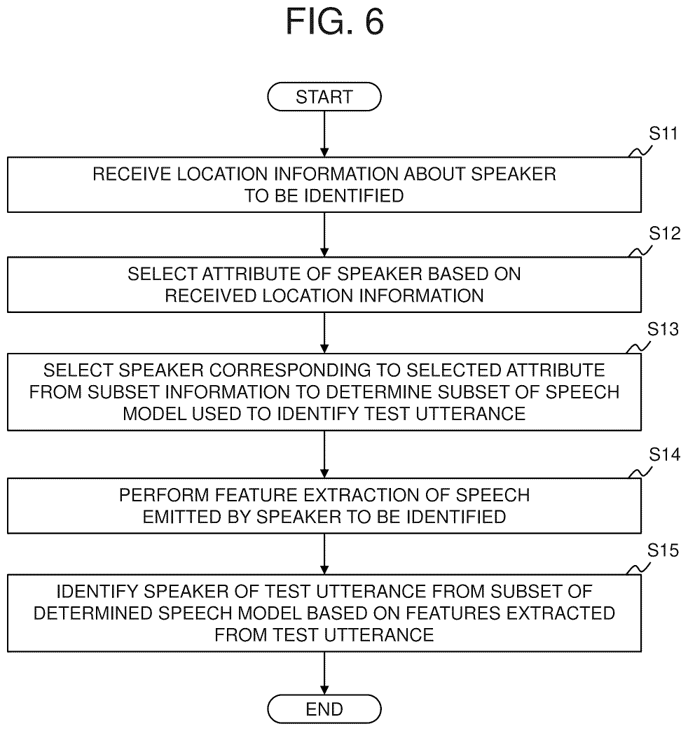

Next, an operation example of the speaker identification apparatus according to the present exemplary embodiment will be described. FIG. 6 depicts a flowchart illustrating the process of the present exemplary embodiment of the speaker identification apparatus 1.

The information receiver 12 receives location information about the speaker to be identified (step S11). The attribute selection unit 14 selects an attribute of the speaker based on the received location information (step S12). Then, the speaker subset selection unit 18 selects the speaker corresponding to the selected attribute from the subset information stored in the mapping information storage unit 16 to determine a subset of the speech model used to identify the test utterance (step S13).

On the other hand, the feature extraction unit 20 performs feature extraction of the speech (i.e., test utterance) emitted by the speaker to be identified (step S14). The speaker identification unit 30 identifies the speaker of the test utterance from the subset of the determined speech model based on the features extracted from the test utterance by the feature extraction unit 20 (step S15).

As described above, in the present exemplary embodiment, the subset detection unit (more specifically, the speaker subset selection unit 18) selects speakers corresponding to the selected attribute based on the location information from the subset information of an entire speaker to determine a subset of a speech model from which test utterance is identified. And the speaker identification unit 30 identifies a speaker of the test utterance from the subset of the determined speech model based on features extracted from the test utterance by the feature extraction unit 20. Therefore, it is possible to improve the efficiency and accuracy of speaker identification.

### Second Exemplary Embodiment

Next, a second exemplary embodiment of the speaker identification apparatus of the present invention will be described. In the first exemplary embodiment, the case where the form for selecting a subset is so-called deterministic (discrete) based on one subset was described. In this exemplary embodiment, the case where the form for selecting a subset is so-called probabilistic (continuous) based on multiple subsets is described.

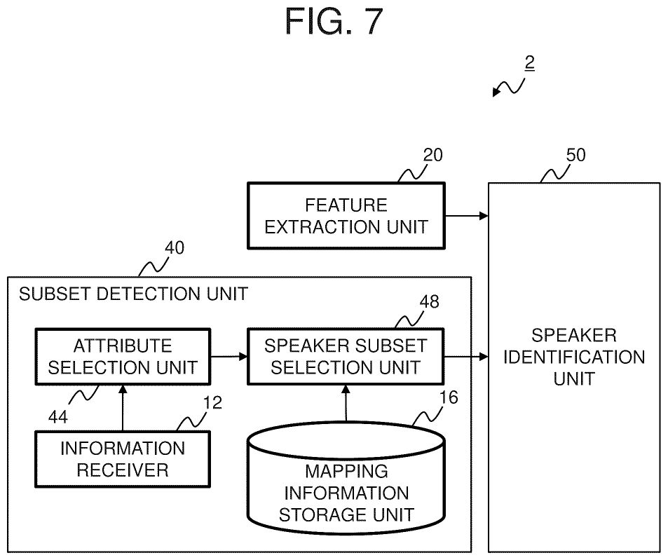

FIG. 7 depicts an exemplary block diagram illustrating the structure of the second exemplary embodiment of a speaker identification apparatus according to the disclosure. The speaker identification apparatus 2 according to the second exemplary embodiment includes a subset detection unit 40, the feature extraction unit 20, and a speaker identification unit 50. The contents of the feature extraction section 20 are the same as in the first exemplary embodiment.

The subset detection unit 40 includes the information receiver 12, an attribute selection unit 44, the mapping information storage unit 16, and a speaker subset selection unit 48. The contents of the information receiver 12 and the mapping information storage unit 16 are the same as in the first exemplary embodiment.

The attribute selection unit 44, like the attribute selection unit 14 of the first exemplary embodiment, selects the attribute of the speaker based on the location information received by the information receiver 12. The attribute selection unit 44 of the present exemplary embodiment selects one or more attributes. A situation in which more than one attribute is selected is, for example, a situation in which more than one attribute is possible from location information and the attribute cannot be uniquely determined. For example, in a prison, a situation in which multiple cell IDs can be inferred from location information, for example.

The speaker subset selection unit 48 selects a plurality of subsets of the speaker from the subset information stored in the mapping information storage unit 16 based on the attribute selected by the attribute selection unit 44. Specifically, the speaker subset selection unit 48 obtains a subset of speakers corresponding to each of the plurality of attributes from the mapping information storage unit 16. As in the first exemplary embodiment, the speaker subset selection unit 48 may obtain a speech model corresponding to the speaker included in the obtained subset from the mapping information storage unit 16 or from an external storage unit.

In addition, the speaker subset selection unit 48 of the present exemplary embodiment calculates a reliability regarding the speech model of each subset. The reliability with respect to the speech model of each subset may be pre-calculated and maintained and may be calculated sequentially by the speaker subset selection unit 48.

The reliability with respect to the speech model of each subset is a value that is set higher the more appropriately the speech model included in the subset represents the features of the speaker, and is a value calculated based on a predetermined criterion. The reliability in this exemplary embodiment includes not only the reliability of the speech model itself, but also the reliability of the attributes (i.e., a subset) selected based on the location information. This is because if the reliability of the selected attribute itself is high, the speech model corresponding to the subset of the attribute is also highly reliable, including the target speaker.

The reliability of the speech model itself, for example, may be used, such as the likelihood and probability calculated during the generation process of each model. For example, the reliability of the model generated based on audio data acquired in a quiet environment may be calculated to be high, and the reliability of the model generated based on audio data acquired in a noisy environment may be calculated to be low.

When a plurality of candidate subsets exist, the reliability of each subset may be defined as the ratio of the individual reliability to the reliability of the overall subset. An example of a method for calculating the reliability when location information is used as prior information is described below. One method for calculating the reliability of a selected attribute based on location information is to use distance and time. This is because, in speaker identification, the more distant the object is, or the further away the identification object is from the time it is likely to be present, the lower the identification accuracy.

For example, if the distance between the location received from the receiver estimating the location of the test utterance (e.g., the position of the robot) and the location where each attribute i (e.g., each cell) of interest exists is dᵢ, the reliability rᵢ of a subset of each attribute i can be calculated by Equation 1 described below. Note that b in Equation 1 is a predetermined value.

$$\begin{matrix}[ Math . 1 ] & \\ {r}_{i} = \frac{{d}_{i}^{b}}{{Σ}_{j} {d}_{j}^{b}} & ( Equation 1 )\end{matrix}$$

Thus, the speaker subset selection unit 48 may calculate the reliability of the subset corresponding to the attribute so that the closer the distance between a position of the receiver estimating the location of the test utterance and a position of the selected attribute, the higher the reliability of the subset corresponding to the attribute.

The speaker identification unit 50, like the speaker identification unit 30 of the first exemplary embodiment, identifies a speaker of the test utterance from a subset of the determined speech model based on the features extracted by the feature extraction unit 20. The speaker identification unit 50 of this exemplary embodiment identifies the speaker of the test utterance so that the more reliable the calculated subset is, the more likely it is to be determined to be the speaker corresponding to the speech model of that subset.

Specifically, the speaker identification unit 50 determines, for each subset, a speech model that has the highest similarity. Next, the speaker identification unit 50 calculates a score for each subset with reliability weighted by similarity. Then, the speaker identification unit 50 identifies the speaker corresponding to the speech model determined within the subset with the highest calculated score as the speaker of the test utterance.

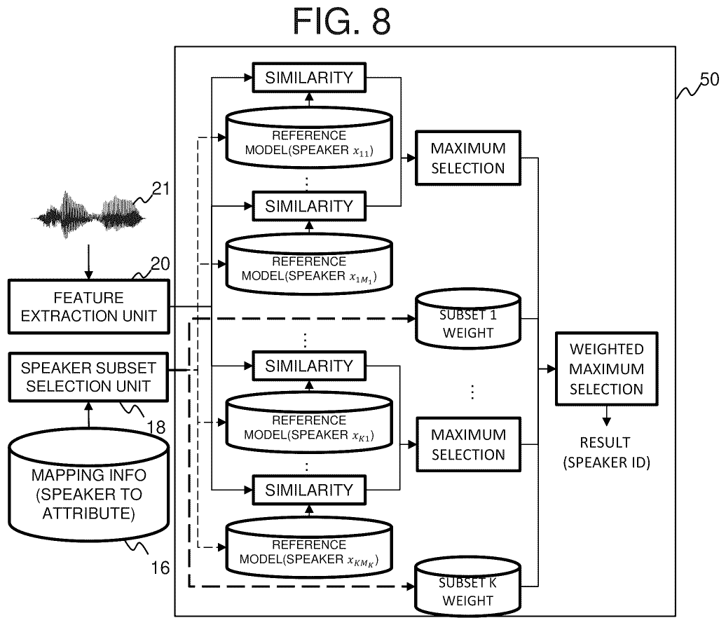

FIG. 8 is an illustration of an example of a method by which the speaker identification apparatus of the present exemplary embodiment performs speaker identification. As in the first exemplary embodiment, the speaker identification unit 50 calculates the similarity between each speaker's speech model and utterances using the speech model MK of each subset K, and selects the speaker with the highest similarity (speaker ID) as the identification result, respectively. Further, the speaker identification unit 50 calculates a score weighted by the reliability of each subset to the similarity calculated for each subset, and identifies the speaker corresponding to the speech model determined within the subset with the highest calculated score as the speaker of the test utterance.

Thus, even when multiple subsets of candidates exist, the accuracy of speaker identification can be further improved because the speaker is identified based on the reliability of each subset.

The subset detection unit 40 (more specifically, the information receiver 12, the attribute selection unit 44, and the speaker subset selection unit 48) are implemented by a CPU of a computer operating according to a program (speaker identification program).

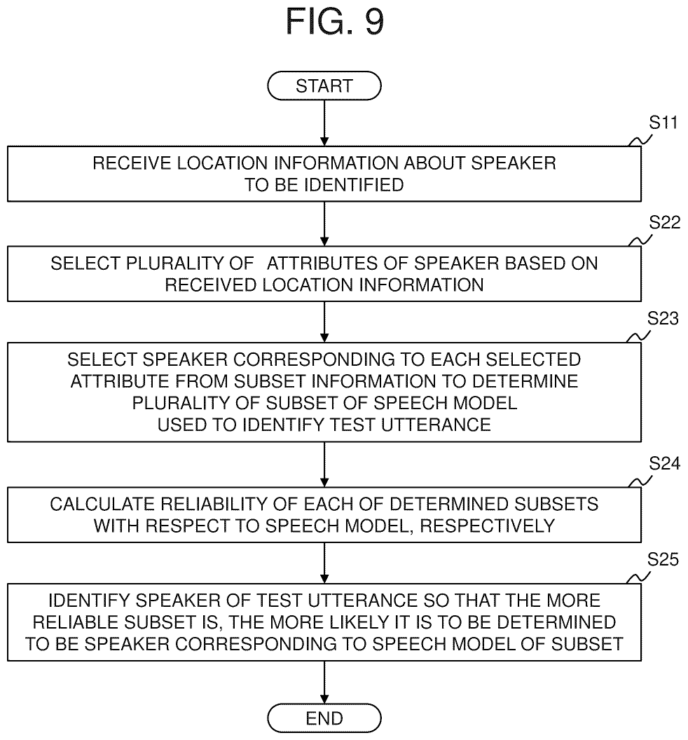

Next, an operation example of the speaker identification apparatus according to the present exemplary embodiment will be described. FIG. 9 depicts a flowchart illustrating the process of the present exemplary embodiment of the speaker identification apparatus 2.

The process of receiving the location information is the same as in step S11 illustrated in FIG. 6. The attribute selection unit 44 selects a plurality of attributes of the speaker based on the received location information (step S22). Then, the speaker subset selection unit 48 selects the speaker corresponding to the each selected attribute from the subset information stored in the mapping information storage unit 16 to determine a plurality of subsets of the speech model used to identify the test utterance (step S23). Furthermore, the speaker subset selection unit 48 calculates the reliability of each of the determined subsets with respect to the speech model, respectively (step 24).

The extraction process of the test utterance is the same as in step S14 illustrated in FIG. 6. The speaker identification unit 50 identifies the speaker of the test utterance based on the features extracted from the test utterance by the feature extraction unit 20 so that the more reliable the subset is, the more likely it is to be determined to be the speaker corresponding to the speech model of the subset (step S25).

As described above, in this exemplary embodiment, the speaker subset selection unit 48 determines a plurality of subsets of the speech model by selecting speakers corresponding to a plurality of each attribute from the subset information of the entire speaker, and calculates a reliability of each of the determined subsets with respect to the speech model. Then, the speaker identification unit 50 identifies the speaker of the test utterance such that the more reliable the subset is, the more likely it is to be determined to be the speaker corresponding to the speech model of the subset. Thus, in addition to the effect of the first exemplary embodiment, it is possible to further improve the accuracy of the speaker identification.

Next, a specific configuration example using the speaker identification apparatus of the disclosure will be described. In the following specific configuration example, a case in which one subset is obtained is described. That is, in the following description, a specific configuration example using the speaker identification apparatus of the first exemplary embodiment will be described. Note that when a plurality of subsets are obtained, the speaker identification apparatus of the second exemplary embodiment may be used.

### Specific Example 1

A first specific example is a form of using the speaker identification apparatus of the disclosure in a situation assumed for meal distribution and plates collection in prison. In order to reduce the human burden in the prison, it is desirable to be able to automate the task of meal distribution and plates collection for individual prisoners. The prerequisite for this is the need to identify the prisoners to be targeted for serving and collecting plates.

It is possible to identify the prisoner who emitted the voice with a certain degree of accuracy by speaker identification. However, as the number of prisoners in the prison increases, the problems of efficiency and accuracy, as described above, arise. In this specific example, the efficiency and accuracy of speaker identification can be improved by selecting the cell ID from the location information and reducing the number of prisoners to be identified by the speaker identification.

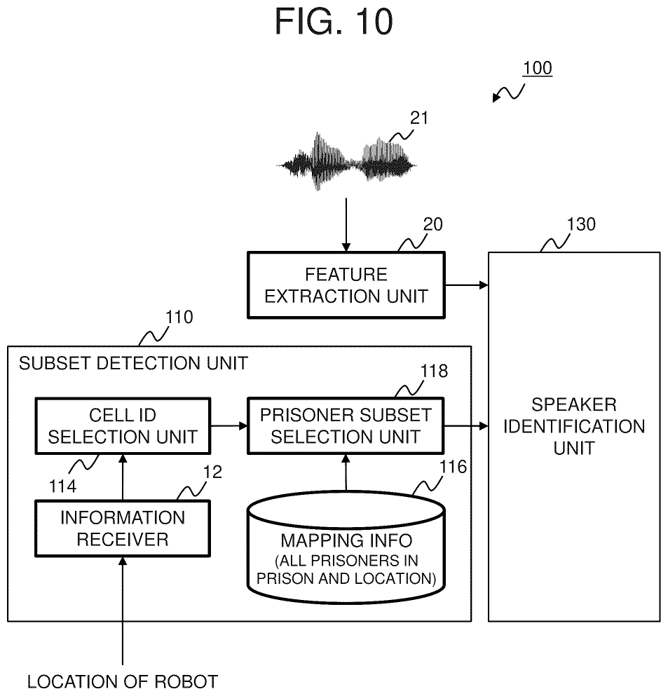

FIG. 10 depicts an exemplary block diagram illustrating the structure of a first specific example of the speaker identification apparatus according to the disclosure. The speaker identification apparatus 100 according to the first specific example includes a subset detection unit 110, the feature extraction unit 20, and a speaker identification unit 130. The contents of the feature extraction section 20 are the same as in the first exemplary embodiment.

The subset detection unit 110 includes the information receiver 12, a cell ID selection unit 114, a mapping information storage unit 116, and a prisoner subset selection unit 118. The contents of the information receiver 12 are the same as in the first exemplary embodiment.

The cell ID selection unit 114 selects a cell ID based on the location information received by the information receiver 12. That is, the cell ID selection unit 114 selects the cell ID as an attribute selected by the attribute selection unit 14 in the first exemplary embodiment. The method of selecting the cell ID from the location information is the same as the method in which the attribute selection unit 14 selects the attribute.

The mapping information storage unit 116 stores information that maps the cell ID to one or more prisoners as subset information. The mapping information storage unit 116 may also store a speech model of each prisoner.

The prisoner subset selection unit 118 selects a subset of the prisoner from the subset information stored in the mapping information storage unit 116 based on the cell ID selected by the cell ID selection unit 114. That is, the prisoner subset selection unit 118 selects the prisoners in the cell identified by the selected cell ID as a subset of all prisoners in the prison. Together, the prisoner subset selection unit 118 obtains the speech model of the selected prisoner.

The speaker identification unit 130 identifies a prisoner of the test utterance from a subset of the determined speech model based on the features extracted by the feature extraction unit 20. The method of speaker identification is the same as the method performed by the speaker identification section 30 in the first exemplary embodiment.

### Specific Example 2

A second specific example is a form of using the speaker identification apparatus of the disclosure in a situation assumed for attendance checker in university lectures. It is desirable to be able to automate the task of checking attendance in order to reduce the human burden on the instructor. As a precondition for this, it is necessary to identify the students who attend the targeted lectures.

It is possible to identify the student who emitted the voice with a certain degree of accuracy by speaker identification. However, as the number of students in the university increases, the problems of efficiency and accuracy, as described above, arise. In this specific example, the efficiency and accuracy of speaker identification can be improved by selecting the lecture from the location information and reducing the number of students to be identified by the speaker identification. To uniquely identify the lecture, it is preferable to use the time information as well.

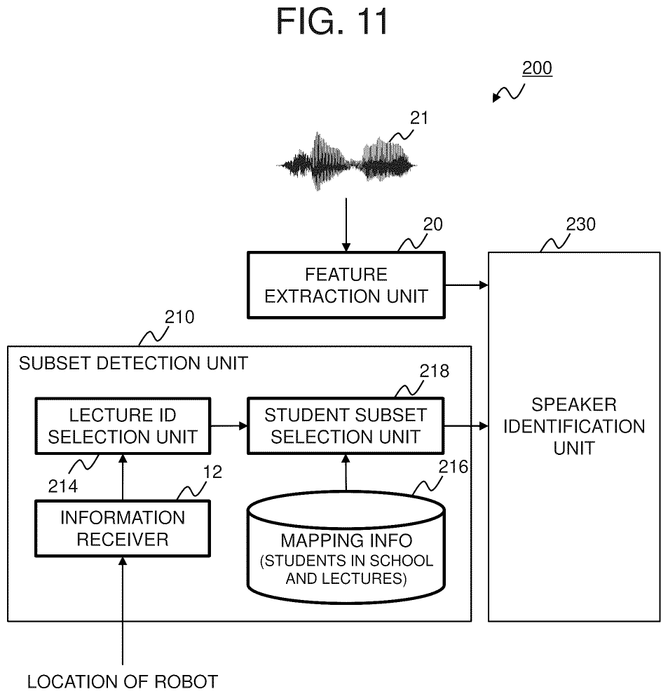

FIG. 11 depicts an exemplary block diagram illustrating the structure of a second specific example of the speaker identification apparatus according to the disclosure. The speaker identification apparatus 200 according to the second specific example includes a subset detection unit 210, the feature extraction unit 20, and a speaker identification unit 230. The contents of the feature extraction section 20 are the same as in the first exemplary embodiment.

The subset detection unit 210 includes the information receiver 12, a lecture ID selection unit 214, a mapping information storage unit 216, and a student subset selection unit 218. The contents of the information receiver 12 are the same as in the first exemplary embodiment.

The lecture ID selection unit 214 selects a lecture ID based on the location information received by the information receiver 12. That is, the lecture ID selection unit 214 selects the lecture ID as an attribute selected by the attribute selection unit 14 in the first exemplary embodiment. The method of selecting the lecture ID from the location information is the same as the method in which the attribute selection unit 14 selects the attribute.

The mapping information storage unit 216 stores information that maps the lecture ID to one or more students as subset information. The mapping information storage unit 216 may also store a speech model of each student.

The student subset selection unit 218 selects a subset of the student from the subset information stored in the mapping information storage unit 216 based on the lecture ID selected by the lecture ID selection unit 214. That is, the student subset selection unit 218 selects the students to attend the lecture identified by the selected lecture ID as a subset of all students in the university. Together, the student subset selection unit 218 obtains the speech model of the selected student.

The speaker identification unit 230 identifies a student of the test utterance from a subset of the determined speech model based on the features extracted by the feature extraction unit 20. The method of speaker identification is the same as the method performed by the speaker identification section 30 in the first exemplary embodiment.

### Specific Example 3

A third specific example is a form of using the speaker identification apparatus of the disclosure in a situation assumed for quarantine subject temperature checking. It is desirable to be able to automate temperature checks on individual quarantine subjects in order to reduce the human burden on hospitals and quarantine stations. As a precondition for this, it is necessary to identify individual quarantine subjects. In this specific example, the efficiency and accuracy of speaker identification can be improved by selecting the room ID from the location information and reducing the number of quarantine subjects to be identified by the speaker identification.

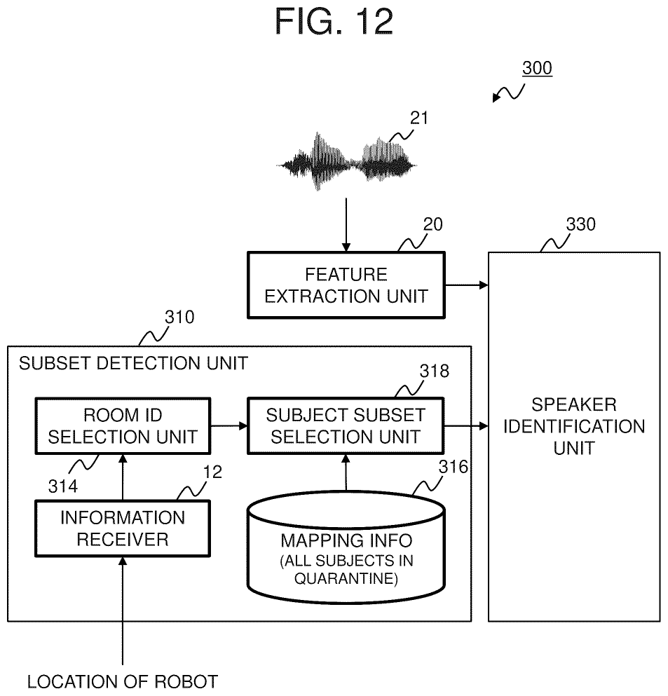

FIG. 12 depicts an exemplary block diagram illustrating the structure of a third specific example of the speaker identification apparatus according to the disclosure. The speaker identification apparatus 300 according to the third specific example includes a subset detection unit 310, the feature extraction unit 20, and a speaker identification unit 330. The contents of the feature extraction section 20 are the same as in the first exemplary embodiment.

The subset detection unit 310 includes the information receiver 12, a room ID selection unit 314, a mapping information storage unit 316, and a subject subset selection unit 318. The contents of the information receiver 12 are the same as in the first exemplary embodiment.

The room ID selection unit 314 selects a room ID based on the location information received by the information receiver 12. That is, the room ID selection unit 314 selects the room ID as an attribute selected by the attribute selection unit 14 in the first exemplary embodiment. The method of selecting the room ID from the location information is the same as the method in which the attribute selection unit 14 selects the attribute.

The mapping information storage unit 316 stores information that maps the room ID to one or more subjects as subset information. The mapping information storage unit 316 may also store a speech model of each subject.

The subject subset selection unit 318 selects a subset of the subject from the subset information stored in the mapping information storage unit 316 based on the room ID selected by the room ID selection unit 314. That is, the subject subset selection unit 318 selects the subjects in the room identified by the selected room ID as a subset of all quarantine subjects. Together, the subject subset selection unit 318 obtains the speech model of the selected subject.

The speaker identification unit 330 identifies a subject of the test utterance from a subset of the determined speech model based on the features extracted by the feature extraction unit 20. The method of speaker identification is the same as the method performed by the speaker identification section 30 in the first exemplary embodiment.

### Specific Example 4

A fourth specific example is a form of using the speaker identification apparatus of the disclosure in a situation assumed for students checking in dormitory after curfew. It is preferable to be able to automate the checking of individual students who return to the dormitory after curfew in order to reduce the human burden on dormitory staff. As a precondition for this, it is necessary to identify the students to be checked. In this specific example, the efficiency and accuracy of speaker identification can be improved by selecting the room ID from the location information and reducing the number of students to be identified by the speaker identification.

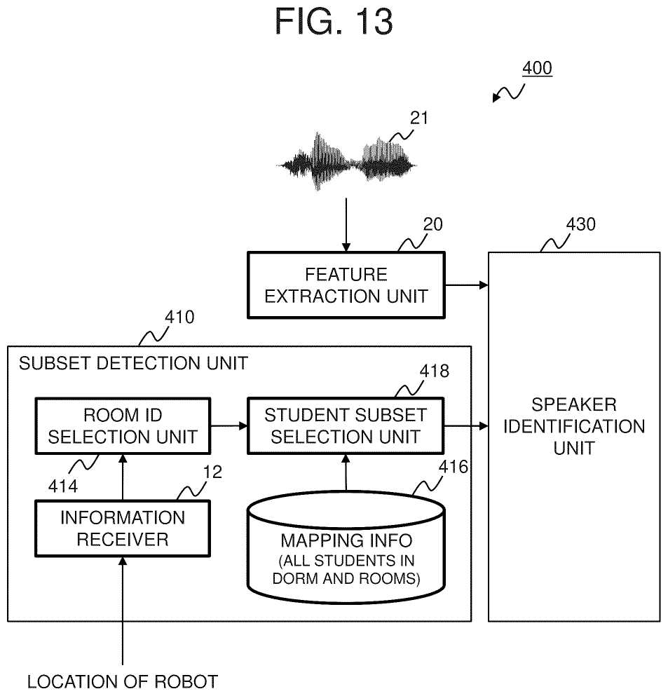

FIG. 13 depicts an exemplary block diagram illustrating the structure of a fourth specific example of the speaker identification apparatus according to the disclosure. The speaker identification apparatus 400 according to the fourth specific example includes a subset detection unit 410, the feature extraction unit 20, and a speaker identification unit 430. The contents of the feature extraction section 20 are the same as in the first exemplary embodiment.

The subset detection unit 410 includes the information receiver 12, a room ID selection unit 414, a mapping information storage unit 416, and a student subset selection unit 418. The contents of the information receiver 12 are the same as in the first exemplary embodiment.

The room ID selection unit 414 selects a room ID based on the location information received by the information receiver 12. That is, the room ID selection unit 414 selects the room ID as an attribute selected by the attribute selection unit 14 in the first exemplary embodiment. The method of selecting the room ID from the location information is the same as the method in which the attribute selection unit 14 selects the attribute.

The mapping information storage unit 416 stores information that maps the room ID to one or more students as subset information. The mapping information storage unit 416 may also store a speech model of each student.

The student subset selection unit 418 selects a subset of the student from the subset information stored in the mapping information storage unit 416 based on the room ID selected by the room ID selection unit 414. That is, the student subset selection unit 418 selects the students in the room identified by the selected room ID as a subset of all students in the dormitory. Together, the student subset selection unit 418 obtains the speech model of the selected student.

The speaker identification unit 430 identifies a student of the test utterance from a subset of the determined speech model based on the features extracted by the feature extraction unit 20. The method of speaker identification is the same as the method performed by the speaker identification section 30 in the first exemplary embodiment.

### Specific Example 5

A fifth specific example is a form of using the speaker identification apparatus of the disclosure in customer management in chain stores. Companies with chain stores often take a form of centralized customer management at the headquarters, for example. In this case, it is usual that the registered stores and frequently used stores are managed together. In this situation, the information about the customers desired at each store is not all customers managed by the headquarters, but a subset of customers who use the store.

In this specific example, the efficiency and accuracy of speaker identification can be improved by selecting the shop ID from the location information and reducing the number of customers to be identified by the speaker identification. In addition, if a customer not in that subset (an outlier customer) comes into the store, they can be recommended to register with the store for future promotions, etc.

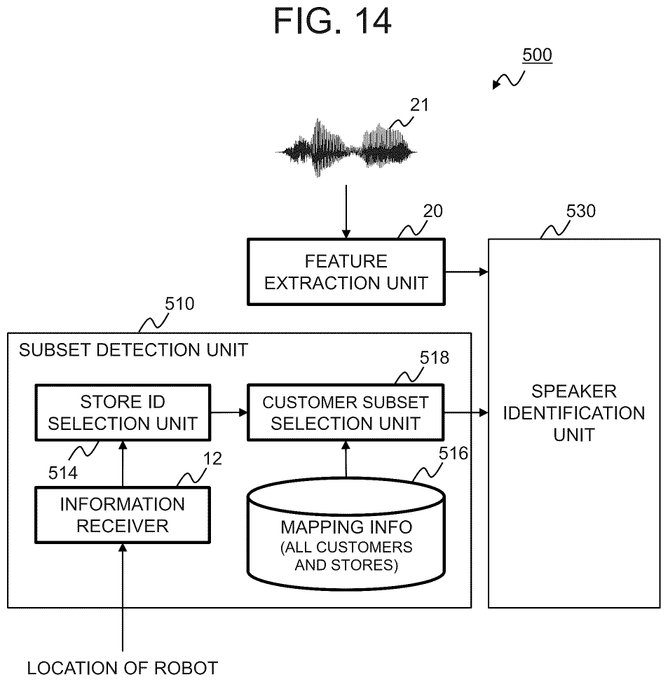

FIG. 14 depicts an exemplary block diagram illustrating the structure of a fifth specific example of the speaker identification apparatus according to the disclosure. The speaker identification apparatus 500 according to the fifth specific example includes a subset detection unit 510, the feature extraction unit 20, and a speaker identification unit 530. The contents of the feature extraction section 20 are the same as in the first exemplary embodiment.

The subset detection unit 510 includes the information receiver 12, a shop ID selection unit 514, a mapping information storage unit 516, and a customer subset selection unit 518. The contents of the information receiver 12 are the same as in the first exemplary embodiment.

The shop ID selection unit 514 selects a shop ID based on the location information received by the information receiver 12. That is, the shop ID selection unit 514 selects the shop ID as an attribute selected by the attribute selection unit 14 in the first exemplary embodiment. The method of selecting the shop ID from the location information is the same as the method in which the attribute selection unit 14 selects the attribute.

The mapping information storage unit 516 stores information that maps the shop ID to one or more customers as subset information. The mapping information storage unit 516 may also store a speech model of each customer.

The customer subset selection unit 518 selects a subset of the customer from the subset information stored in the mapping information storage unit 516 based on the shop ID selected by the shop ID selection unit 514. That is, the customer subset selection unit 518 selects the customers identified by the selected room ID as a subset of all registered customers. Together, the customer subset selection unit 518 obtains the speech model of the selected customer.

The speaker identification unit 530 identifies a customer of the test utterance from a subset of the determined speech model based on the features extracted by the feature extraction unit 20. The method of speaker identification is the same as the method performed by the speaker identification section 30 in the first exemplary embodiment.

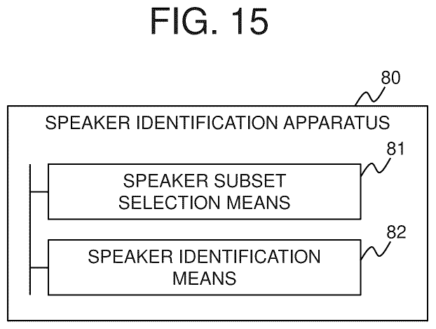

Next, an outline of the disclosure will be described. FIG. 15 depicts a block diagram illustrating an outline of the speaker identification apparatus according to the disclosure. The speaker identification apparatus 80 (for example, speaker identification apparatus 1) including: a speaker subset selection means 81 (e.g., speaker subset selection unit 18) which selects speakers corresponding to attribute from subset information of an entire speaker to determine a subset of a speech model from which test utterance (e.g., test utterance 21) is identified; and a speaker identification means 82 (e.g., speaker identification unit 30) which identifies a speaker of the test utterance from a subset of the determined speech model based on features extracted from the test utterance.

With such a configuration, it is possible to improve the efficiency and accuracy of speaker identification.

The speaker subset selection means 81 (e.g., speaker subset selection unit 48) may determine a plurality of subsets of the speech model by selecting speakers corresponding to a plurality of each attribute from the subset information of the entire speaker, and calculate a reliability of each of the determined subsets with respect to the speech model. Then, the speaker identification means 82 (e.g., speaker identification unit 50) may identify the speaker of the test utterance such that the more reliable the subset is, the more likely it is to be determined to be the speaker corresponding to the speech model of the subset.

Specifically, the speaker subset selection means 81 may calculate the reliability of the subset corresponding to the attribute so that the closer the distance between a position of the receiver (e.g., a robot) estimating the location of the test utterance and a position of the selected attribute, the higher the reliability of the subset corresponding to the attribute.

The speaker identification means 82 may calculate similarity between the speech model in the subset and the features, and identify the speaker corresponding to the speech model with the highest similarity as the speaker of the test utterance.

The speaker identification means 82 may calculate a score weighted by the reliability of the subset concerned to the similarity calculated for each subset, and identify the speaker corresponding to the speech model determined within the subset with the highest calculated score as the speaker of the test utterance.

The speaker identification apparatus 80 may further include: an information receiver (e.g., information receiver 12) which receives a location from the receiver to estimate the location of the test utterance; and an attribute selection means (e.g., attribute selection unit 14) which selects the attribute based on the received location. Then, the speaker subset selection means 81 may select a speaker corresponding to the selected attribute from the subset information of an entire speaker.

The speaker identification apparatus 80 may further include a feature extraction means (e.g., feature extraction unit 20) which extracts the features of the test utterance. Then, the speaker identification means 82 may identify a speaker of the test utterance based on the extracted features.

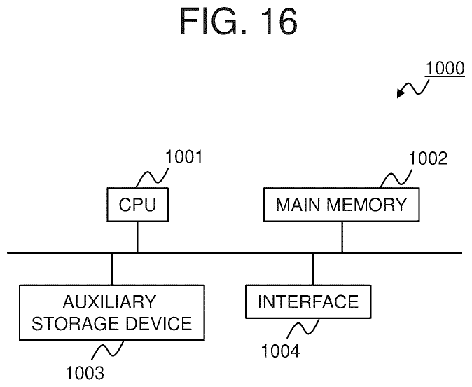

FIG. 16 depicts a schematic block diagram illustrating a configuration of a computer according to at least one of the exemplary embodiments. A computer 1000 includes a CPU 1001, a main storage device 1002, an auxiliary storage device 1003, and an interface 1004.

Each of the above-described hyper-parameter parameter optimization system is mounted on the computer 1000. The operation of the respective processing units described above is stored in the auxiliary storage device 1003 in the form of a program (a speaker identification program). The CPU 1001 reads the program from the auxiliary storage device 1003, deploys the program in the main storage device 1002, and executes the above processing according to the program.

Note that at least in one of the exemplary embodiments, the auxiliary storage device 1003 is an exemplary non-transitory physical medium. Other examples of non-transitory physical medium include a magnetic disc, a magneto-optical disk, a CD-ROM, a DVD-ROM, and a semiconductor memory that are connected via the interface 1004. In the case where the program is distributed to the computer 1000 by a communication line, the computer 1000 distributed with the program may deploy the program in the main storage device 1002 to execute the processing described above.

Incidentally, the program may implement a part of the functions described above. The program may implement the aforementioned functions in combination with another program stored in the auxiliary storage device 1003 in advance, that is, the program may be a differential file (differential program).

While the invention has been particularly shown and described with reference to example embodiments thereof, the invention is not limited to these embodiments. It will be understood by those of ordinary skill in the art that various changes in form and details may be made therein without departing from the spirit and scope of the disclosure as defined by the claims.

The whole or part of the example embodiments disclosed above can be described as, but not limited to, the following supplementary notes.

(Supplementary note 1) A speaker identification apparatus comprising:
a speaker subset selection means which selects speakers corresponding to an attribute from subset information of an entire speaker to determine a subset of a speech model from which test utterance is identified; and
a speaker identification means which identifies a speaker of the test utterance from a subset of the determined speech model based on features extracted from the test utterance.

(Supplementary note 2) The speaker identification apparatus according to Supplementary note 1,
wherein the speaker subset selection means determines a plurality of subsets of the speech model by selecting speakers corresponding to a plurality of each attribute from the subset information of the entire speaker, and calculates a reliability of each of the determined subsets with respect to the speech model, and
the speaker identification means identifies the speaker of the test utterance such that the more reliable the subset is, the more likely it is to be determined to be the speaker corresponding to the speech model of the subset.

(Supplementary note 3) The speaker identification apparatus according to Supplementary note 2,
wherein the speaker subset selection means calculates the reliability of the subset corresponding to the attribute so that the closer the distance between a position of the receiver estimating the location of the test utterance and a position of the selected attribute, the higher the reliability of the subset corresponding to the attribute.

(Supplementary note 4) The speaker identification apparatus according to any one of Supplementary notes 1 to 3,
wherein the speaker identification means calculates similarity between the speech model in the subset and the features, and identifies the speaker corresponding to the speech model with the highest similarity as the speaker of the test utterance.

(Supplementary note 5) The speaker identification apparatus according to Supplementary note 4,
wherein the speaker identification means calculates a score weighted by the reliability of the subset concerned to the similarity calculated for each subset, and identifies the speaker corresponding to the speech model determined within the subset with the highest calculated score as the speaker of the test utterance.

(Supplementary note 6) The speaker identification apparatus according to any one of Supplementary notes 1 to 5, further comprising:
an information receiver which receives a location from the receiver to estimate the location of the test utterance; and
an attribute selection means which selects the attribute based on the received location,
wherein the speaker subset selection means selects a speaker corresponding to the selected attribute from the subset information of an entire speaker.

(Supplementary note 7) The speaker identification apparatus according to any one of Supplementary notes 1 to 6, further comprising a feature extraction means which extracts the features of the test utterance,
wherein the speaker identification means identifies a speaker of the test utterance based on the extracted features.

(Supplementary note 8) The speaker identification apparatus according to any one of claims 1 to 7,
wherein the speaker subset selection means selects speakers corresponding to the selected attribute based on location information or attribute information.

(Supplementary note 9) A speaker identification method comprising:
selecting speakers corresponding to an attribute from subset information of an entire speaker to determine a subset of a speech model from which test utterance is identified; and
identifying a speaker of the test utterance from a subset of the determined speech model based on features extracted from the test utterance.

(Supplementary note 10) The speaker identification method according to Supplementary note 9,
a plurality of subsets of the speech model is determined by selecting speakers corresponding to a plurality of each attribute from the subset information of the entire speaker, and a reliability of each of the determined subsets with respect to the speech model is calculated, and
the speaker of the test utterance is identified such that the more reliable the subset is, the more likely it is to be determined to be the speaker corresponding to the speech model of the subset.

(Supplementary note 11) A non-transitory computer readable information recording medium storing a speaker identification program, when executed by a processor, that performs a method for:
selecting speakers corresponding to an attribute from subset information of an entire speaker to determine a subset of a speech model from which test utterance is identified; and
identifying a speaker of the test utterance from a subset of the determined speech model based on features extracted from the test utterance.

(Supplementary note 12) A non-transitory computer readable information recording medium according to Supplementary note 11, the speaker identification program further performs a method for:
determining a plurality of subsets of the speech model by selecting speakers corresponding to a plurality of each attribute from the subset information of the entire speaker, and calculating a reliability of each of the determined subsets with respect to the speech model, and
identifying the speaker of the test utterance such that the more reliable the subset is, the more likely it is to be determined to be the speaker corresponding to the speech model of the subset.

(Supplementary note 13) A speaker identification program for causing a computer to execute:
a speaker subset selection process of selecting speakers corresponding to an attribute from subset information of an entire speaker to determine a subset of a speech model from which test utterance is identified; and
a speaker identification process of identifying a speaker of the test utterance from a subset of the determined speech model based on features extracted from the test utterance.

(Supplementary note 14) A speaker identification program according to Supplementary note 13, wherein
in the speaker subset selection process, the computer is made to determine a plurality of subsets of the speech model by selecting speakers corresponding to a plurality of each attribute from the subset information of the entire speaker, and calculate a reliability of each of the determined subsets with respect to the speech model, and
in the speaker identification process, the computer is made to identify the speaker of the test utterance such that the more reliable the subset is, the more likely it is to be determined to be the speaker corresponding to the speech model of the subset.

### REFERENCE SIGNS LIST

1, 2, 100, 200, 300, 400, 500 speaker identification apparatus
10, 40, 110, 210, 310, 410, 510 subset detection unit
12 information receiver
14 attribute selection unit
16, 116, 216, 316, 416, 516 mapping information storage unit
18, 48 speaker subset selection unit
20 feature extraction unit
21 test utterance
30, 130, 230, 330, 430, 530 speaker identification unit
114 cell ID selection unit
118 prisoner subset selection unit
214 lecture ID selection unit
218, 418 student subset selection unit
314, 414 room ID selection unit
318 subject subset selection unit
514 store ID selection unit
518 customer subset selection unit

What is claimed is:

1. A speaker identification apparatus comprising:
a memory storing instructions; and
one or more processors configured to execute the instructions to:
select speakers corresponding to an attribute from subset information of an entire speaker to determine a subset of a speech model from which test utterance is identified; and
identify a speaker of the test utterance from a subset of the determined speech model based on features extracted from the test utterance.

2. The speaker identification apparatus according to claim 1,
wherein the processor is configured to execute the instructions to: determine a plurality of subsets of the speech model by selecting speakers corresponding to a plurality of each attribute from the subset information of the entire speaker, and calculate a reliability of each of the determined subsets with respect to the speech model; and
the speaker identification means identify the speaker of the test utterance such that the more reliable the subset is, the more likely it is to be determined to be the speaker corresponding to the speech model of the subset.

3. The speaker identification apparatus according to claim 2,
wherein the processor is configured to execute the instructions to calculate the reliability of the subset corresponding to the attribute so that the closer the distance between a position of the receiver estimating the location of the test utterance and a position of the selected attribute, the higher the reliability of the subset corresponding to the attribute.

4. The speaker identification apparatus according to claim 1,
wherein the processor is configured to execute the instructions to calculate similarity between the speech model in the subset and the features, and identify the speaker corresponding to the speech model with the highest similarity as the speaker of the test utterance.

5. The speaker identification apparatus according to claim 4,
wherein the processor is configured to execute the instructions to calculate a score weighted by the reliability of the subset concerned to the similarity calculated for each subset, and identify the speaker corresponding to the speech model determined within the subset with the highest calculated score as the speaker of the test utterance.

6. The speaker identification apparatus according to claim 1, wherein the processor is configured to execute the instructions to:
receive a location from the receiver to estimate the location of the test utterance;
select the attribute based on the received location; and
select a speaker corresponding to the selected attribute from the subset information of the entire speaker.

7. The speaker identification apparatus according to claim 1, wherein the processor is configured to execute the instructions to: extract the features of the test utterance; and
identify a speaker of the test utterance based on the extracted features.

8. The speaker identification apparatus according to claim 1,
wherein the processor is configured to execute the instructions to select speakers corresponding to the selected attribute based on location information or attribute information.

9. A speaker identification method comprising:
selecting speakers corresponding to an attribute from subset information of an entire speaker to determine a subset of a speech model from which test utterance is identified; and
identifying a speaker of the test utterance from a subset of the determined speech model based on features extracted from the test utterance.

10. The speaker identification method according to claim 9,
a plurality of subsets of the speech model is determined by selecting speakers corresponding to a plurality of each attribute from the subset information of the entire speaker, and a reliability of each of the determined subsets with respect to the speech model is calculated, and
the speaker of the test utterance is identified such that the more reliable the subset is, the more likely it is to be determined to be the speaker corresponding to the speech model of the subset.

11. A non-transitory computer readable information recording medium storing a speaker identification program, when executed by a processor, that performs a method for:
selecting speakers corresponding to an attribute from subset information of an entire speaker to determine a subset of a speech model from which test utterance is identified; and
identifying a speaker of the test utterance from a subset of the determined speech model based on features extracted from the test utterance.

12. A non-transitory computer readable information recording medium according to claim 11, the speaker identification program further performs a method for:
determining a plurality of subsets of the speech model by selecting speakers corresponding to a plurality of each attribute from the subset information of the entire speaker, and calculating a reliability of each of the determined subsets with respect to the speech model, and
identifying the speaker of the test utterance such that the more reliable the subset is, the more likely it is to be determined to be the speaker corresponding to the speech model of the subset.
